(19) United States
(12) Patent Application Publication
(10) Pub. No.: US 2025/0293523 A1
(43) Pub. Date: Sep. 18, 2025

(54) Hybrid Renewable Energy Power Plant and Battery Energy Storage Systems

(71) Applicant: Saeed Daneshvardehnavi, Essen (DE)

(72) Inventor: Saeed Daneshvardehnavi, Essen (DE)

(73) Assignee: RWE Clean Energy, LLC, Austin, TX (US)

(21) Appl. No.: 18/608,367

(22) Filed: Mar. 18, 2024

(51) Int. Cl. H02J 3/32; H02J 3/38; H02J 3/46

(52) U.S. Cl. CPC H02J 3/32; H02J 3/381; H02J 3/46; H02J 2300/24

(57) ABSTRACT

A system including at least one renewable energy power plant with a DC source port. The DC source port is electrically connected to a DC input port of a first inverter and at least one battery energy storage system (BESS) with a DC connection port. The DC connection port is electrically connected to a DC input port of a second inverter. A DC/DC converter is electrically arranged in between the DC source port and the DC connection port.

### FIELD OF THE DISCLOSURE

The subject matter relates to renewable energy power plants, in particular photovoltaic (PV) systems, which are operated in combination with battery energy storage systems (BESS). The subject matter relates to the connection of these systems to an AC grid and the connection between these systems. The subject matter moreover relates to a skid (aka as frame, terminal box, junction box or the like) design for such systems. The subject matter relates to a hybrid renewable energy power plant/BESS system.

### BACKGROUND

The integration of Solar Photovoltaic (PV) systems with Battery Energy Storage Systems (BESS) represents a cutting-edge advancement in renewable energy technology. This synergy addresses the inherent intermittency of solar power generation, offering a solution to the energy storage challenge and contributing to the overall resilience and sustainability of the power grid.

One of the primary reasons for the growing interest in Solar-BESS coupled systems is their ability to enhance energy reliability. Solar power generation is contingent on sunlight availability, and BESS provides a means to store excess energy during peak production periods. This stored energy can be deployed during periods of low solar generation, ensuring a consistent and reliable power supply, even during adverse weather conditions or at night.

Solar-BESS systems contribute significantly to grid stability by mitigating the impact of fluctuations in energy production. The rapid response capabilities of BESS allow for effective demand management and grid balancing. This integration enables utilities to address peak demand periods more efficiently, reducing strain on the grid and enhancing overall stability.

Apart from grid-related advantages, Solar-BESS systems contribute to environmental sustainability. By capturing and storing excess solar energy, these systems help reduce dependence on conventional power sources, thereby lowering greenhouse gas emissions. The integration aligns with global efforts to transition towards cleaner, more sustainable energy solutions, making it a pivotal component in combating climate change.

The economic benefits of Solar-BESS systems are multifaceted. They enable cost savings through peak shaving, reducing the need for additional infrastructure to meet high-demand periods. Additionally, the extended lifespan of batteries and decreasing costs of solar panels contribute to the long-term viability of these systems, making them an economically sound investment for both utilities and end-users.

It is an object of the subject matter to provide for a renewable energy power plant, e.g. a Solar Photovoltaic Systems with a Battery Energy Storage Systems (BESS), which provides for increased efficiency, increased reliability over current Solar Photovoltaic systems with Battery Energy Storage Systems (BESS).

### SUMMARY OF THE INVENTION

In order to overcome shortcomings of current systems, there is provided a system comprising, at least one renewable energy power plant with a DC source port, wherein the DC source port is electrically connected to a DC input port of a first inverter, at least one battery energy storage system (BESS) with a DC connection port, wherein the DC connection port is electrically connected to a DC input port of a second inverter, and wherein a DC/DC converter is electrically arranged in between the DC source port and the DC connection port.

In the following, solar photovoltaic systems are predominantly described. However, it should be noted that the description is also to be understood to encompass other renewable energy power plants, in particular electrical power plants which are fed from renewable energy, such as wind turbines, marine power, biomass power, tidal power, geothermal power or the like. In the following, the term power plant may be used as synonym for any of the a.m. electrical power sources.

According to embodiments, the DC source is a DC power source. According to embodiments, the DC source is comprised of at least two PV panels.

According to embodiments, the DC ports are connected to a DC bus, in particular a busbar. The DC bus is, according to embodiments, an input port of the first inverter. The input port can be on the DC side of the first inverter. The first inverter may be considered a PV inverter. The first inverter can have an AC side electrically opposite the DC side.

According to embodiments, at least one, preferably two BESS are connected to another DC bus, in particular a busbar. The another DC bus is, according to embodiments, an input port of the second inverter. The input port can be on the DC side of the second inverter. The second inverter may be considered a BESS inverter. The second inverter can have an AC side electrically opposite the DC side.

The first inverter and the second inverter are, according to embodiments, connected at their AC sides to a substation. The connections can be via separate feeder lines. The substation can have separate terminals for each feeder line. Each terminal can be separately fused.

According to embodiments, the DC source port can also be understood as DC power outlet, DC power connection, DC bus, DC link or the like. DC power can be understood as electric DC power. DC power is usually transferred using two wires, each per pole. A port can have separate connections for each pole. In the following, oftentimes only singular is used for the term port, terminal, connection, outlet or the like. It goes without saying that on the DC side, this encompasses at least two poles, being insulated from each other and carrying different electrical potentials.

On the DC side, the source port may have a potential between the poles between 12V and 2000V, in particular 48V, 100V, 800V, 1000V or 1500V. It should be noted that the claimed subject matter is independent from any voltage levels and it can be applied to any DC input of any kind of inverter and in any sizes.

The DC potential depends on the number and/or size and/or capability of the PV modules being connected in series. It should be noted that the DC ports mentioned herein are configured to have a dielectric strength being at least a factor of 1.5, preferably a factor of between 2 and 5 higher than the maximum potential between the poles.

It should be noted that the DC source port is electrically connected to a DC input port of a first inverter. This is in particular a two pole connection between the DC source port and the DC input port of the first inverter. The voltage is according to the above. The current carrying capacity of this connection can be higher than 100A, potentially higher than 1000A. It should be noted that the claimed subject matter is independent from any current levels and it can be applied to any DC input of any kind of inverter and in any sizes. The currents can be configured according to the rate of the inverters.

The first inverter can be configured to connect the DC side of the system to the AC side of the system. The AC side of the system can be a three-phase system with three phases L1, L2 and L3, neutral N and ground PE. The potential of the phases can be low voltage, e.g. from 200V up to between 1 kV and 1.5 kV, medium voltage, e.g. from between 1 kV and 1.5 kV up to between 30 kV and 50 kV, high voltage, e.g. from between 30 kV and 50 kV up to between 60 kV and 150 kV and above, for instance between 200 kV and 400 kV. The AC output side can be configured for such voltages, e.g. to have at least a corresponding dielectric strength. The AC side can have a frequency of between 25 Hz and 100 Hz, preferably 25 Hz (Rail) or 50 Hz (Europe) or 60 Hz (North America).

According to the subject matter, there is provided at least one battery energy storage system (BESS). A BESS is a storage system having a plurality of battery cells being interconnected electrically in parallel and in series to have a given pole voltage at its DC connection port and to be able to output and store the electrical power at a given current level and a give voltage.

On the DC side, the DC connection port may have a potential between the poles between 12V and 2000V, in particular 48V, 100V, 800V, 1000V or 1500V. It should be noted that the claimed subject matter is independent from any voltage levels and it can be applied to any DC input of any kind of inverter and in any sizes. The DC potential depends on the number and/or size of the battery modules being connected in series.

It should be noted that the DC connection output port is electrically connected to a DC input port of a second inverter. This is in particular a two pole connection between the DC connection port and the DC input port of the second inverter. The voltage is according to the above. The current carrying capacity of this connection can be higher than 100A, potentially higher than 1000A. It should be noted that the claimed subject matter is independent from any current levels and it can be applied to any DC input of any kind of inverter and in any sizes.

The BESS or more than one BESS can be electrically coupled via the DC connection port to a DC input port of a second inverter.

The second inverter can be configured to connect the DC side of the system to the AC side of the system. The AC side of the system can be a three-phase system as described above. The AC side is particularly the identical for the first and the second inverter in terms of phases, potential, frequency and the like.

The first inverter and the second inverter can be connected, preferably via a respective transformer to one common grid. As will be shown below, the connection between the inverters on the power source/BESS side and a substation can be done with separate feeder lines for the power source and the BESS, i.e. each inverter can be connected be a separate feeder line to the substation. The substation can act as relay between the inverters and the grid. Each feeder line can be connected to a Point of Interconnection POI at the substation. The first inverter and the second inverter can be configured to have a different or a same potential at their AC output ports. The first inverter and/or the second inverter can be configured to have a frequency and/or a phase aligned with a frequency and a phase of the grid, e.g. either one or both can be grid driven inverters. The inverters can be configured in a grid following manner. The first inverter and/or the second inverter can be configured to have a frequency and/or a phase being self configured, e.g. either one or both can be self-configuring inverters. In such a case, the self configured inverter is capable of being operated in an islanding mode, i.e. being cut off from the grid. The inverters can be configured in a grid forming manner. In particular, both inverters are configured in a grid following or grid forming manner (mode).

The BESS is configured to have at its DC connection port, the same or a different voltage as the maximum voltage at the DC source port. Nevertheless, it should be noted that the DC voltage at the DC source port is subject to volatility, i.e. depending on the instant renewable source, e.g. instant solar power, the voltage level changes at high rates. In order to mitigate the volatility at the DC source port, there is proposed, besides the two inverters, a DC/DC converter being electrically arranged in between the DC source port and the DC connection port. Thus, the DC/DC converter enables power transfer between the power plant and the BESS on the DC side, while at the same time, the first inverter enables power transfer from the power plant to the grid and the second inverter enables power transfer from the BESS to the grid. The DC/DC converter enables curtailed clipping in high power times. When the power plant, e.g. due to high solar energy being available at the PV modules, provides for electrical power above the rated power of the first inverter, the surplus of power is not wasted, but can be provided via the DC/DC converter to the BESS. In low power times when the power plant, e.g. due to low solar energy being available at the PV modules (morning, evening, cloudy weather) provides for electrical power below a minimum required power for operating the first inverter, the output power can still be harvested via the DC/DC converter and stored within the BESS. The DC/DC converter can have a lower minimum required power for operation than the first inverter. When the power of the power plant ramps up, in particular when solar energy is provided, this ramp usually is not a regular ramp and very steep. In particular the change between cloudy and sunny can happen within seconds. This can cause steep ramps of the output power. However, the grid requires controlled ramps, i.e. according to utility or ISO (Independent System Operator) requirements or grid code. The DC/DC converter can be used to shape the ramp, i.e. by shaving peaks due to transfer of power to the BESS and by lifting down slopes due to transfer of power from the BESS.

Moreover, there is provided a system comprising, at least one renewable energy power plant and at least one battery energy storage system (BESS), wherein the renewable energy power plant is coupled to an AC grid via an inverter, and the BESS is coupled to the grid via a further inverter, and wherein the renewable energy power plant and the battery energy storage system are directly coupled with each other via a DC/DC converter.

Another aspect is a system comprising, at least one renewable energy power plant and at least one battery energy storage system (BESS), wherein the renewable energy power plant is connected to a bus bar and the bus bar is coupled to an AC grid via an inverter and a DC/DC converter, and the BESS is coupled to the grid via a further inverter, and wherein the renewable energy power plant and the battery energy storage system are directly coupled with each other via a DC/DC converter.

A further aspect is a method for operating such a system, wherein electric power is provided by the renewable energy power plant at the DC source port and wherein the provided electrical power is fed through both the first and the second inverter.

The subject matter relates in particular to a solar photovoltaic (PV) system with Battery Energy Storage Systems (BESS). The inventor has found that it is beneficial to combine DC/DC coupling between the renewable energy power plant and the battery energy storage systems (BESS) on the DC side and in parallel to connect the renewable energy power plant via a first inverter to a grid and the BESS via a second, different inverter to the grid. The inventors have found that DC/DC coupling on the DC side between these power plant and the BESS enables increased energy harvesting, reduced clipping, lower voltage harvesting, time shifting of grid feeding, feeding ramp control and more.

As explained above, current topologies either have a coupling between the power plant and the BESS on the AC side or on the DC side. Either of these topologies has shortcoming. In particular, either topology is not able to capture all the generated power. Thus, lots of available energy is lost due to system constraints.

The inventors found that the hybrid approach as explained herein enables to maximize and optimize the overall energy provided from the system to the grid. The system as claimed gives more flexibility, reliability, and power generation in peak time to be provided to the grid or stored within the BESS.

Since the BESS is AC coupled using the second inverter, the BESS can be operated on a separated feeding line and is placed near to substations. The BESS system can be charged and discharged by the grid and get benefits of ancillary services of AC coupling.

The proposed modifications and connections create a new and more efficient topology for PV-BESS systems.

According to embodiments, the second inverter and the BESS are spatially located besides the first inverters, in particular within a common structure.

The DC/DC converter as claimed enables, on the DC side, a direct link between the DC side of the power plant and the DC side of the BESS. Moreover, on the DC side, the second inverter is directly coupled to the DC/DC converter.

The DC/DC converter adds flexibility and a DC connection between both DC sides of the first and second inverter. This enables that DC power can be easily flow between those two inverters.

Due to the DC/DC coupling of the power plant and the BESS, the BESS can be charged directly from the power plant, independently from a rated power of the first inverter. Thus, the DC connection between the inverters allows the power plant to have a peak power beyond the rated power of the first inverter. Since the power production itself, in particular using PV modules, is among the least expensive parts in a renewable power plant, the addition of PV modules without the need to care about the rated power of the first inverter enables increased power production due to more PV installed modules.

This may in particular be relevant in retrofitting existent power plants. According to an embodiment, it is proposed that an existing PV power plant with BESS, wherein power plant and BESS are already AC coupled, is equipped with a DC/DC converter as explained herein. This allows for increasing the peak power of the power plant, e.g. more PV modules, without the need to retrofit the first inverter.

The DC/DC coupling enables energy being usually clipped due to constraints of rated power of the first inverter, now being provided to the BESS and stored therein.

The advantage of this new proposed hybrid topology lies in the combined coupling on both the AC side and the DC side.

According to embodiments it is proposed that the grid is connected to the BESS and the power plant via a respective, separate feeder line. It is proposed that the output of the second inverter is provided to a grid connection point via a feeder line being separated from the feeder line which couples the output of the first inverter to the grid connection point. Within each feeder line there can be a separate line protection, circuit breaker and/or fuse. Within each feeder line there can be a separate transformer.

According to embodiments, a system is proposed wherein an AC output port of the first inverter is electrically connected to a secondary side port of a first transformer. In between the first inverter and the grid connection point there may be a transformer. The transformer enables decoupling of the grid from the first inverter.

According to embodiments, a system is proposed, wherein a primary side port of the first transformer is electrically connected to an input port of a first breaker, in particular a load disconnector. The primary side of a transformer can be understood as the grid side. For safety reasons, the first transformer, along the first feeder line, is connected to the grid with at least one first circuit breaker. This enables to disconnect the first transformer and the first inverter from the grid.

According to embodiments, a system is proposed, wherein the DC input port of the first inverter, the first transformer and the first breaker are electrically connected to a first feeder line. The first breaker prior to the feeder line allows for decoupling of the system with inverter, transformer, DC/DC converter, power plant and BESS from the grid and the connection to the grid. This allows for electrically protecting the system from damages on the connection to the grid and grid faults.

According to embodiments, a system is proposed, wherein an output port of the first breaker is electrically connected to a first feeder port of a substation. The system, via the first breaker and the first feeder port, can be connected to a substation. The substation can be arranged to be connected to two or more systems. Each system can have a feeder port at the first inverter/transformer and, as explained later, a feeder port at the second inverter/transformer. These separate feeder lines enable the substation to be connected, along a common first feed, with a plurality of first inverters on the one hand and, along a common second feed, with a plurality of second inverters on the one hand. This enables separation of the feed of the substation by the power plants via the first common feed and by the BESSs via the second common feed.

According to embodiments, a system is proposed, wherein at least two, preferable more than two first feeder lines are electrically connected to the first feeder of the substation. The first feeder of the substation can be the first common feed. At substation level, more than on of the described hybrid systems, can be interconnected and connected to the grid. To separate the feeds from the power plants and the BESSs of the different systems, each feed is connected to a common feeder, i.e. the common first feed and the common second feed.

According to embodiments, a system is proposed, wherein an AC output port of the second inverter is electrically connected to a secondary side port of a second transformer. As explained for the first inverter, the same applies for the second inverter, with the difference, that power being fed via the second inverter in the first place stems from the BESS.

According to embodiments, a system is proposed, wherein a primary side port of the second transformer is electrically connected to an input port of a second breaker, in particular a load disconnector. The primary side of a transformer can be understood as the grid side. For safety reasons, the second transformer, along the second feeder line, is connected to the grid with at least one second circuit breaker. This enables to disconnect the second transformer and the second inverter from the grid.

According to embodiments, a system is proposed, wherein the DC input port of the second inverter, the second transformer and the second breaker are electrically connected to a second feeder line. The second breaker prior to the second feeder line allows for decoupling of the system with inverters, transformers, DC/DC converter, power plant and BESS from the grid and the connection to the grid. This allows for electrically protecting the system from damages on the connection to the grid and grid faults.

According to embodiments, a system is proposed, wherein an output port of the second breaker is electrically connected to a second feeder port of the substation. The system, via the second breaker and the second feeder port, can be connected to a substation. The substation can be arranged to be connected to two or more systems. Each system can have, as explained above, a feeder port at the second inverter/transformer and, as explained here, a feeder port at the second inverter/transformer. These separate feeder lines enable the substation to be connected, along a common second feed, with a plurality of second inverters on the one hand and, along a common first feed, with a plurality of first inverters on the one hand. This enables separation of the feed of the substation by the power plants via the first common feed and by the BESSs via the second common feed.

According to embodiments, a system is proposed, wherein at least two, preferable more than two second feeder lines are electrically connected to the second feeder of the substation. The second feeder of the substation can be the second common feed. At substation level, more than one of the described hybrid systems, can be interconnected and connected to the grid. To separate the feeds from the power plants and the BESSs of the different systems, each feed is connected to a common feeder, i.e. the common first feed and the common second feed.

According to embodiments, a system is proposed, wherein at least two first feeder lines are electrically connected to the first feeder port of the substation and least two second feeder lines are electrically connected to a second feeder port of the substation. As explained above, more than one hybrid system can be connected to the substation. Via the separate first feeder port the first feeding lines of a plurality of systems can be interconnected and via the separate second port the second feeding lines of a plurality of systems can be interconnected. The output of the feeding ports can be connected to each other. Using the separate feeding port, it is possible to provide for energy metering at each feeder port separately. Then, when also taking into account the power transferred via the DC/DC converter, it is possible to determine the energy provided by the power plant directly and the power provided by the BESS. Also, the energy fed into the BESS from the grid via the second feeding line can also be measured.

According to embodiments, a system is proposed, wherein the DC source port comprises an anode terminal and a cathode terminal. AS explained above, the DC side has two poles, e.g. an anode terminal and a cathode terminal.

According to embodiments, a system is proposed, wherein least two, preferably more than two anode terminals of DC source terminals of different renewable energy power plants are electrically connected to a common anode busbar and/or least two, preferably more than two cathode terminals of DC source terminals of different renewable energy power plants are electrically connected to a common cathode busbar. It has been found that PV modules or modules of other power plant can be interconnected with each other for instance in a common skid using a common bus bar. For anode and cathode potential one common bus bar may be provided for interconnecting more than on power plant modules, e.g. PV modules, on the DC side with each other. This enables collecting power from a plurality of modules on the DC side and provide the power via a common bus bar to the first inverter and the DC/DC converter.

According to embodiments, a system is proposed, wherein the renewable energy power plant is comprised of at least one photovoltaic (PV) module, in particular an array of electrically connected PV modules. It has been explained above that the hybrid approach is particularly useful for PV power plants, since these have the described volatile power production, which can be mitigated using the BESS.

According to embodiments, a system is proposed, wherein the DC/DC converter has two connection ports, each with two terminals. This accounts for the DC side having the two poles, anode and cathode.

According to embodiments, a system is proposed, wherein an anode terminal of a first connection port of the DC/DC converter is electrically connected to the anode bus bar and/or a cathode terminal of the first connection port of the DC/DC converter is electrically connected to the anode bus bar. Each connection terminal on the DC side is connected to one of the two bus bars.

According to embodiments, a system is proposed, wherein at least the DC/DC converter, the first and second inverters, the first and second transformers and the first and second breakers are arranged in a common skid. It is proposed that the BESS is spatially located close to the power plant, e.g. the PV module. By providing a common skid within which the inverters, transformers and DC/DC converter are arranged simultaneously, the placement of BESS and PV close to each other is supported. Also, the common skid makes wiring effort less and reduced the wiring length and thus ohmic losses along the wiring.

According to embodiments, a system is proposed, wherein the bus bars are arranged within the common skid. When the bus bars are already provided within the skid, the wiring is made easy and fast.

According to embodiments, a system is proposed, wherein the bus bars have connection terminals within the common skid for electrically connecting DC power terminals. It is proposed that the wiring within the skid is prefabricated, i.e. the wiring within the skid is done off site, in production facility, and on site wiring, at the power plant and the BESS is reduced to connecting the power plant to the bus bars and the BESS to the DE/DC converter and the second inverter.

According to embodiments, a system is proposed, wherein the skid has at the breakers connections terminals for the feeder lines. The connection of the system to the substation is thus also reduced to connecting the feeder lines to the skid. The circuit breakers allow for disconnecting the assembly within the skid from the grid.

According to embodiments, a system is proposed, wherein the skid has connection terminals for the DC connection terminals. This makes the connection of the BESS to the assembly within the skid easy.

Another aspect is a method for operating the system of one of the preceding claims, wherein electric power is provided by the renewable energy power plant at the DC source port and wherein the provided electrical power is fed through both the first and the second inverter.

The method can be supervised and carried out by a processor, in particular a processor within the skid. The processor may be connected with sensors and actors, in order to enable power flow as described above, to open and close circuit breakers according to needs, to monitor the power plant and the BESS, in particular a Battery Management System of the BESS and to provide for operational data to a SCADA system.

According to embodiments it is proposed that at least two BESS are electrically connected to the DC input terminal and a respective battery management system of each of the BESS enables charging or discharging of the BESS depending on at least a state of charge (SOC) of the respective BESS. The processor may monitor the SOC of the respective BESS and charging and discharging power may be controlled based on the SOC of each of a plurality of BESS.

According to embodiments, it is possible to provide for power flow to and from the first and second inverters. In particular in discharge mode, the grid is fed with power via the second inverter. In case electrical power is produced within the power plant, electrical power can also be fed via the first inverter.

According to embodiments, there is provided a method wherein when the electrical power at the DC source port exceeds the maximum rated power of the first inverter, the electrical power is fed through the DC/DC converter to charge the BESS and in parallel through the first and the second inverter. The output power to the grid is only limited by the combined rated powers of the first and second inverters. Unlike previous systems electrical power from both the BESS and the power plant can be fed via two inverters to the grid. The discharge can be used for provision of primary reserve and/or secondary reserve. The discharge can also be used as reactive power reserve.

It is proposed that the DC/DC converter is bi-directional, thus allowing electrical power flow in both directions.

In charging mode, the grid may charge the BESS. This can be used for provision of primary reserve and/or secondary reserve. The charging can also be used as reactive power reserve. Also, the charging can be used for peak shaving. The charging power can be higher than common systems, since power can flow via the second inverter to the BESS and the first inverter and the DC/DC coupler to the BESS.

In case the power at the power plant exceeds the rated power of the first inverter, unlike known systems, this power needs not to be clipped. The power can in addition be fed via the DC/DC converter to the second inverter and then the grid and/or to the BESS for charging.

The provided system enables also a redundant operation. In case one of the two inverters has failed or is maintained, power can still flow to and from the grid via the respective other inverter. It is proposed that electrical power from at least one of the DC source port or the BESS bypasses the first inverter and is fed to the second inverter or bypasses the second inverter and is fed to the first inverter.

### BRIEF DESCRIPTION OF THE DRAWINGS

In the drawings show:

FIG. 1 is a skid assembly according to embodiments;

FIG. 2 is a system topology according to embodiments;

FIGS. 3a-c are various operational functions according to embodiments;

FIG. 4 is an embodiment of a skid.

### DETAILED DESCRIPTION

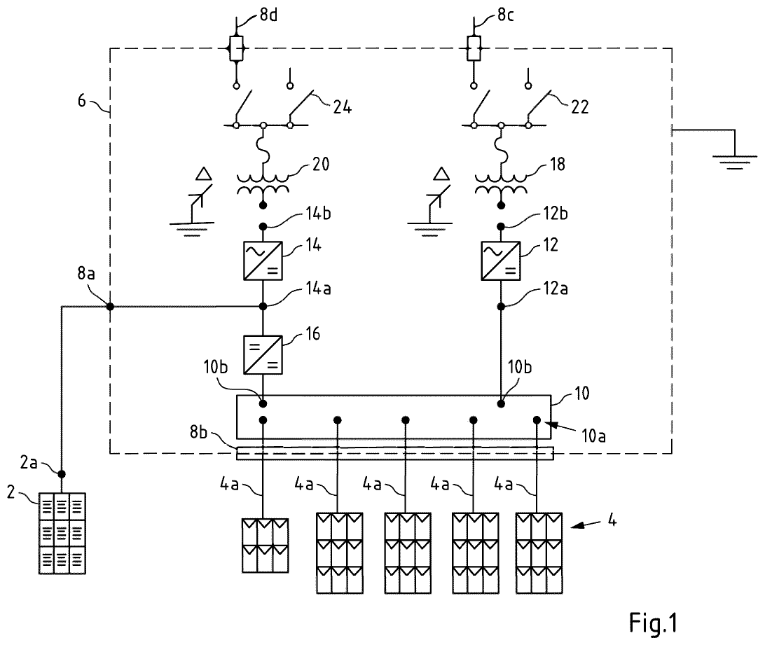

FIG. 1 illustrates an assembly according to embodiments.

Illustrated is a battery energy storage system 2 (BESS), which can be comprised of a plurality of battery cells and a battery management system (BMS).

Further illustrated are photovoltaic (PV) modules 4. There can be one, two of more PV modules. It is preferred that a plurality of PV modules are connected in series in strings and each string is connected to the assembly as described. Each PV module 4 has a DC source port 4a, which is used for DC connecting the PV modules 4 to an assembly as described.

Shown is, in dashed lines, a skid 6. The skid 6 can be a frame, installation frame, rack or the like. The skid 6 can be a compartment or cabinet being arranged for taking up the assembly as described. The skid 6 can be preconfigured off-site. It is proposed that the skid 6 is mounted and wired off site and then brought to the installation site, where the PV module 4 and the BESS 2 are already or will be installed.

The skid 6 may have a metallic casing, which, as shown, can be grounded to common ground PE.

The skid 6 may have various connection terminals 8. The skid 6 can be a compartment, with open sides for accessing the arrangement inside and the connection terminals 8 at its outside for wiring as described.

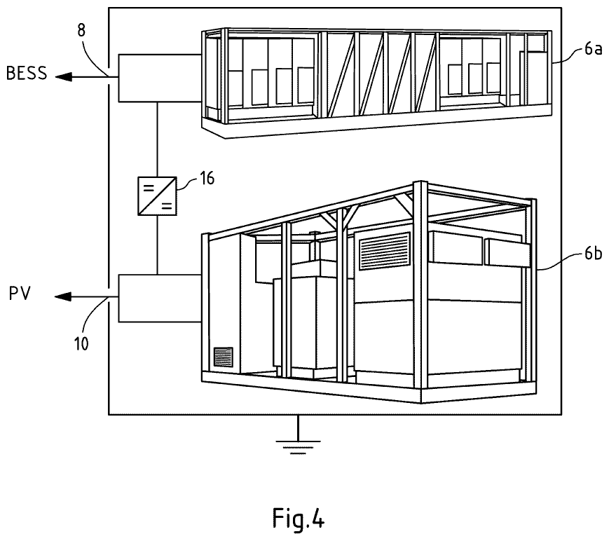

The skid can be a single piece or can be made from multiple pieces. For instance, as shown in FIG. 4, the skid 6 can be comprised of a skid 6a for the BESS inverter 14 and a skid 6b for the solar inverter 12. As shown in FIG. 4, the connection terminal 8 for connecting to the BESS can be a bus bar. Also, the connection terminal 10 for connecting the PV modules can be a bus bar. In between the skids 6a, 6b, there can be placed the DC/DC converter 16. The output terminals 8c, 8c of the skids 6a, 6b, being connected to separated feeder lines 28b, 28a are not shown in FIG. 4. Within the skids, not only the inverters 12, 14 are installed, but also the transformer 20 and the circuit breaker 24 can be installed within skid 6a, and the transformer 18 and the circuit breaker 22 can be installed in skid 6b. When skid 6 is used in singular, the arrangement of FIG. 4 is considered to be encompassed by that terminology.

There can be a first DC connection terminal 8a for connecting the BESS 2 to the skid 6. There can be a second DC connection terminal 8b, which can be comprised of a plurality of terminals 8b, each of which for connecting one set/string of PV modules 4, e.g. the DC source port 4a. The DC connection terminal 8b can also be understood as DC source port.

These terminals 8a and 8b are DC terminals with two poles and two polarities (anode/cathode).

On the AC side, there can be terminals 8c and 8d. A first terminal 8c can be used for connecting a first feeding line for connection with a substation 30 and a second terminal 8d can be used for connecting a second feeding line for connection to a substation. The terminals 8c, 8d can be AC terminals with three poles L1, L2, L3 and a pole for neutral N and a PE pole.

The skid 6 can thus enclose the arrangement as described below and connected in total to the outside via the terminals 8.

Within the skid, there are bus bars 10, one for each polarity (anode/cathode). The bus bars are high current busbars with a high current carrying capacity (based on the requirements) for instance of over 1000A. Each terminal 8b may have a separated tap 10a on the bus bar 10. Each bus bar may have to taps 10b for connecting to the inverters and DC/DC converter.

A first inverter 12 is connected to a tap 10b. The first converter 12 is connected with its DC input terminal 12a to tap 10b.

The first inverter 12 is connected with its AC output terminal 12b to a transformer 18.

A second inverter 14 is connected with its DC input terminal 14a to a DC/DC converter 16. The DC/DC converter 16 is connected to tap 10b. Between second inverter 14 and DC/DC converter 16, the BESS is connected with its DC connection terminal 2a via terminal 8a.

The second inverter is connected with its AC output terminal 14b to a transformer 20.

Transformer 18 is connected to a first circuit breaker 22 and transformer 20 is connected to a second circuit breaker 24. The first circuit breaker 22 is connected to first terminal 8c. The second circuit breaker is connected to the second terminal 8d.

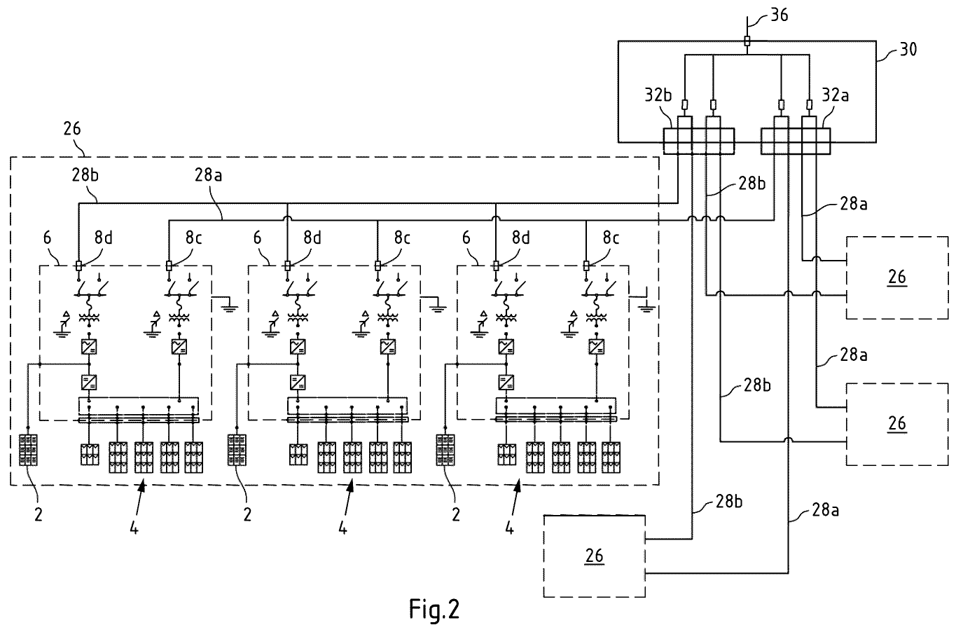

The skid 6 is provided for a connection between BESS 2 and PV modules 4 using DC/DC coupling and AC coupling to the grid at the same time. The AC coupling is shown in FIG. 2.

FIG. 2 illustrates 4 assemblies 26, each of which comprised of at least one skid 6 being connected, as described to a respective at least one BESS 2 and a respective at least one PV module 4.

At the respective terminals 8c there is connected a first feeder line 28a and at the respective terminals 8d there is connected a second feeder line 28b.

The first feeder line 28a may be connected to a plurality of first terminals 8c within an assembly 26. The second feeder line 28a may be connected to a plurality of second terminals 8c within an assembly 26.

From each assembly 26, one first feeder line 28a and one second feeder line 28b may be routed to a substation 30. The substation 30 may have at least one first feeder port 32a and at least one second feeder port 32b. At each first feeder port 32a there are taps for connecting at least two feeder lines 28a from respective assemblies 26 and each second feeder port 32b there are taps for connecting at least two feeder lines 28b from respective assemblies 26. Each tap is protected by a separate circuit breaker. All taps of one port 32a, 32b are guided to a power meter and from there, all feeder ports 32a, 32b are combined and connected to one grid connection point 36.

Within the skid 6 and/or within the assembly 26 and/or within the substation 30 there is a processor programmed for operating the system as described above and below.

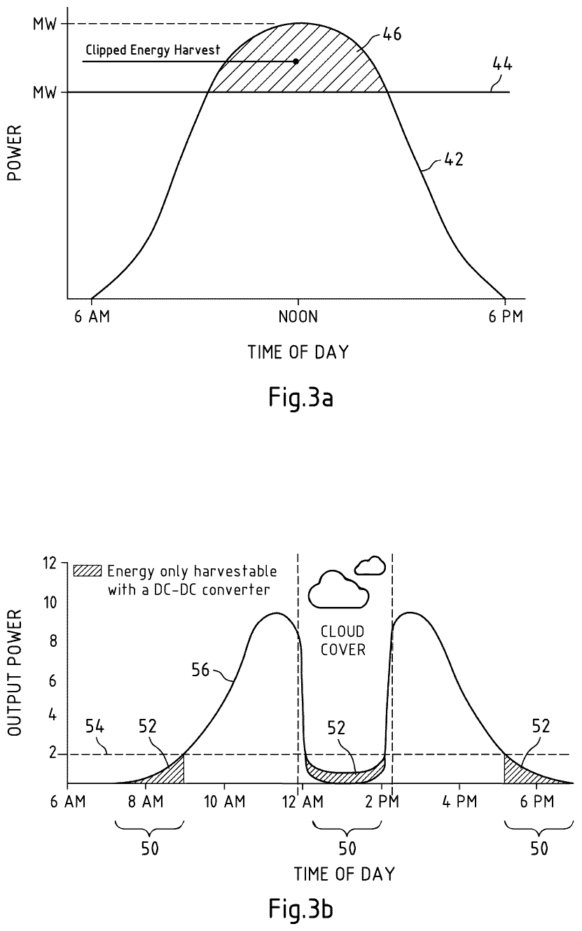

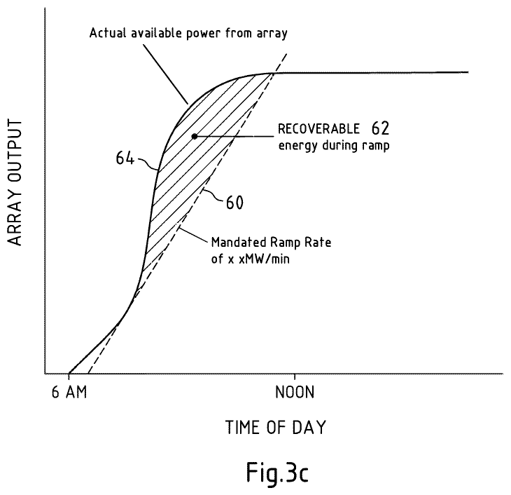

In the realm of utility-scale PV systems, where the challenge of clipping—resulting from inverter limitations—exists, the incorporation of energy storage BESS 2 emerges as a viable solution. Clipping occurs when the inverter 12 reaches its maximum AC output and adjusts the PV DC array voltage away from the maximum power point, leading to the loss of potential energy. This can be seen in FIG. 3a.

Different from present solutions, the amount of clipped energy 46 can be reduced or eliminated. Due to the two inverters 12, 14, it is possible to provide more energy at higher power to the grid than with one single inverter 12. From the PV modules 4, power is guided via inverter 12 to the grid and at the same time through DC/DC converter 16 and inverter 14 to the grid. This causes a raise of the maximum transferrable power, which is depicted by line 44. However, even when power slope 42 of the power generated by PV modules 4 exceeds line 44, the system enables storing energy in BESS 2. Thus, power routed via DC/DC converter 16 is not only fed into the grid via inverter 14, but also to BESS 2 to charge the batteries.

The integration of energy storage enables the capture of excess PV output during instances of peak inverter ratings, effectively preventing the wastage of valuable energy. Notably, the use of DC-coupled BESS enables efficiently recapturing clipped DC output, ensuring optimal system performance and maximizing revenue potential.

In times with low power at the PV modules 4, the current system provides benefits. The integration of energy storage BESS 2 on the DC side behind first inverter 12 offers continuous uptime and enhanced revenue generation. During scheduled or unplanned outages of the inverter 12, the BESS 2 can maintain the DC side voltage, allowing the flow of energy from the PV modules 4 to the BESS 2 via a DC/DC converter 16. This ensures that energy can be harvested and stored for later use even when the inverter 12 is offline.

Similarly, in situations where a large utility-scale array is curtailed by the ISO or utility, common in regions with high solar penetration like California, a DC-coupled energy storage system enables uninterrupted energy production. The excess energy produced during curtailment can be stored and discharged once curtailment restrictions are lifted, maximizing overall system efficiency.

Moreover, in low power times, as shown in FIG. 3b, energy harvesting is possible.

PV inverters like inverter 12 typically necessitate a minimum DC side voltage to operate, with a ‘wake-up’ threshold 54, often around 500 VDC on a 1,500 VDC nominal system. During times 50, e.g. mornings, evenings, or under cloud coverage, when the voltage 56 at PV modules 4 and bus bar 10 is below this threshold 54, generated energy goes uncaptured in known systems.

Integrating BESS 2 with a DC/DC converter 16 allows harvesting this energy 52 from the margins. Whether it's the early and late hours of the day or moments of cloud coverage, a DC-coupled energy storage system as claimed can capture this otherwise lost energy. This unique capability is made possible by the DC/DC converter 16 with voltage source capability, providing an avenue to maximize energy capture and revenue generation.

Provision of solar energy to the grid can be shifted with the integration of the BESS and DC/DC coupling to exploit peak periods (e.g. primary reserve times) and higher power purchase agreement rates.

Moreover, grid code, utility or ISO require ramping up the power provided according to a given ramp rate 60, as shown in FIG. 3c. By providing power in times 62, when the power 64 at the PV modules 4 is above the ramp 60 via the DC/DC converter 16 to the BESS 2, the slope of the power ramp up at the grid can follow the required ramp rate 60.

The integration of BESS 2 with PV modules 4 ensures continuous monitoring and modulation of source 60 to meet utility and requirements for controlled ramp rates. Beyond regulatory benefits, this setup recaptures excess energy 62, presenting an additional avenue to optimize revenue from utility-scale PV modules 4.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A system comprising,
at least one renewable energy power plant with a DC source port, wherein the DC source port is electrically connected to a DC input port of a first inverter,
at least one battery energy storage system (BESS) with a DC connection port, wherein the DC connection port is electrically connected to a DC input port of a second inverter, and
wherein a DC/DC converter is electrically arranged in between the DC source port and the DC connection port.

2. The system of claim 1, wherein an AC output port of the first inverter is electrically connected to a secondary side port of a first transformer.

3. The system of claim 1, wherein a primary side port of the first transformer is electrically connected to an input port of a first breaker, in particular a load disconnector.

4. The system of claim 1, wherein the DC input port of the first inverter, the first transformer and the first breaker are electrically connected to a first feeder line.

5. The system of claim 1, wherein an output port of the first breaker is electrically connected to a first feeder port of a substation.

6. The system of claim 1, wherein at least two, preferable more than two first feeder lines are electrically connected to the first feeder of the substation.

7. The system of claim 1, wherein an AC output port of the second inverter is electrically connected to a secondary side port of a second transformer.

8. The system of claim 1, wherein a primary side port of the second transformer is electrically connected to an input port of a second breaker, in particular a load disconnector.

9. The system of claim 1, wherein the DC input port of the second inverter, the second transformer and the second breaker are electrically connected to a second feeder line.

10. The system of claim 1, wherein an output port of the second breaker is electrically connected to a second feeder port of the substation.

11. The system of claim 1, wherein at least two, preferable more than two second feeder lines are electrically connected to the second feeder of the substation.

12. The system of claim 1, wherein at least two first feeder lines are electrically connected to the first feeder port of the substation and least two second feeder lines are electrically connected to a second feeder port of the substation.

13. The system of claim 1, wherein the DC source port comprises an anode terminal and a cathode terminal.

14. The system of claim 1, wherein least two, preferably more than two anode terminals of DC source terminals of different renewable energy power plants are electrically connected to a common anode busbar and/or least two, preferably more than two cathode terminals of DC source terminals of different renewable energy power plants are electrically connected to a common cathode busbar.

15. The system of claim 1, wherein the renewable energy power plant is comprised of at least one photovoltaic (PV) module, in particular an array of electrically connected PV modules.

16. The system of claim 1, wherein the DC/DC converter has two connection ports, each with two terminals.

17. The system of claim 1, wherein an anode terminal of a first connection port of the DC/DC converter is electrically connected to the anode bus bar and/or a cathode terminal of the first connection port of the DC/DC converter is electrically connected to the anode bus bar.

18. The system of claim 1, wherein at least the DC/DC converter, the first and second inverters, the first and second transformers and the first and second breakers are arranged in a common skid.

19. The system of claim 1, wherein the bus bars are arranged within the common skid.

20. The system of claim 1, wherein the bus bars have connection terminals within the common skid for electrically connecting DC power terminals.

21. The system of claim 1, wherein the skid has at the breakers connections terminals for the feeder lines.

22. The system of claim 1, wherein the skid has connection terminals for the DC connection terminals.

23. A system comprising,
at least one renewable energy power plant and
at least one battery energy storage system (BESS),
wherein the renewable energy power plant is coupled to an AC grid via an inverter, and the BESS is coupled to the grid via a further inverter, and
wherein the renewable energy power plant and the battery energy storage system are directly coupled with each other via a DC/DC converter.

24. A system comprising,
at least one renewable energy power plant and
at least one battery energy storage system (BESS),
wherein the renewable energy power plant is connected to a bus bar and the bus bar is coupled to an AC grid via an inverter and a DC/DC converter, and the BESS is coupled to the grid via a further inverter, and
wherein the renewable energy power plant and the battery energy storage system are directly coupled with each other via a DC/DC converter.

25. A method for operating the system of claim 1, wherein
electric power is provided by the renewable energy power plant at the DC source port and wherein the provided electrical power is fed through both the first and the second inverter.

26. The method of claim 25, wherein
when the electrical power at the DC source port exceeds the maximum rated power of the first inverter, the electrical power is fed through the DC/DC converter to charge the BESS and in parallel through the first and the second inverter.

27. The method of claim 25, wherein
at least two BESS are electrically connected to the DC input terminal and a respective battery management system of each of the BESS enables charging or discharging of the BESS depending on at least a state of charge of the respective BESS.

28. The method of one of claims 25, wherein
electrical power from at least one of the DC source port or the BESS bypasses the first inverter and is fed to the second inverter or bypasses the second inverter and is fed to the first inverter.
